(19) United States
(12) Patent Application Publication
(10) Pub. No.: US 2003/0065715 A1
(43) Pub. Date: Apr. 3, 2003

(54) System and method of a wireless thin-client, server-centric framework

(76) Inventors: William R. Burdick JR., Overland Park, KS (US); George F. Santamarina, Overland Park, KS (US)

Correspondence Address: DORSEY & WHITNEY LLP, INTELLECTUAL PROPERTY DEPARTMENT, 50 SOUTH SIXTH STREET, MINNEAPOLIS, MN, 55402-1498, US

(21) Appl. No.: 10/219,463

(22) Filed: Aug. 15, 2002

Related U.S. Application Data
(60) Provisional application No. 60/313,927, filed on Aug. 20, 2001.

(51) Int. Cl. G06F 15/16

(52) U.S. Cl. 709/203; 709/217

(57) ABSTRACT

The present invention provides a Mobile Classic Blend (“MCB”) wireless system. The MCB wireless system has a server component, client component, and application component for building thin-client wireless applications. The MCB wireless system is optimized for use on medium-latency wireless networks (less than 600 ms round-trip). The MCB wireless system allows two-way dynamic updating capabilities that are currently unable with standard wireless solutions, such as WAP and HTTP. Furthermore, the MCB wireless system allows server-centric programming such that developers do not have to write any client code, yet the developers can create a thin-client wireless application that keeps the look-and-feel of a standalone, native PDA application.

### CROSS-REFERENCE TO RELATED APPLICATION(S)

This utility patent application claims the benefit of the provisional patent application, serial No. 60/313,927, filed on Aug. 20, 2001, subject matter of which is incorporated herewith by reference.

### FIELD OF THE INVENTION

The present invention relates generally to a wireless network system and method, and more particularly, to a system and method of implementing a wireless thin-client, server-centric framework.

### BACKGROUND OF THE INVENTION

A typical wireless network architecture is composed of a server computer, a network, and a wireless data device (also often referred to as “a wireless client device”), such as a computer, a phone, or a Personal Data Assistant (PDA), etc. The network may be a public network, such as the Internet, or a private proprietary network. The network moves data packets between a wireless network interface and the server computer. A wireless carrier antenna transfers data packets to and from a wireless device antenna. The signals received at the wireless device antenna are decoded into data packets that are understood by the wireless data device.

A thin client is referred to as a program on a client device which displays a user interface for a server-based application. Thin-clients run minimal or no user application code, i.e. most (if not all) of the application code runs on the server. Examples of thin-clients are Web Browsers, Citrix, X-Windows and PCAnywhere. Because of network characteristics, thin clients are generally not feasible over a typical wireless network. A typical wireless network makes the support of a thin client difficult because of the limited amount of network bandwidth available for transferring a large volume of data, and more seriously, the high latency of a wireless network.

Accordingly, there is a need for an improved wireless network system and method, i.e. a wireless network system and method capable of implementing a wireless thin-client, server-centric framework.

### SUMMARY OF THE INVENTION

To solve the above and the other problems, the present invention provides a Mobile Classic Blend (“MCB”) wireless system. The MCB wireless system has a server component, client component, and application component for building thin-client wireless applications. The MCB wireless system is optimized for use on medium-latency wireless networks (less than 600 ms round-trip). The MCB wireless system allows two-way dynamic updating capabilities that are currently unable with standard wireless solutions, such as WAP and HTTP. Furthermore, the MCB wireless system allows server-centric programming such that developers do not have to write any client code, yet the developers can create a thin-client wireless application that keeps the look-and-feel of a standalone, native PDA application.

In one embodiment of the present invention, the MCB wireless system provides a feature of widget state caching.

Still in one embodiment of the present invention, the MCB wireless system provides a feature of one-way and two-way messages.

Further in one embodiment of the present invention, the MCB wireless system provides a feature of reducing the size of the client execution stack during the unmarshalling of incoming messages from a remote object request broker (ORB).

Yet in one embodiment of the present invention, the MCB wireless system provides a feature of optimizing memory utilization on client devices with limited processing capabilities.

Further yet in one embodiment of the present invention, the MCB wireless system provides a feature of data compression during marshaling.

Still in one embodiment of the present invention, the MCB wireless system provides a feature of MCB-S (server) screen analysis cache.

Further in one embodiment of the present invention, the MCB wireless system provides a feature of a Short Message Service (SMS) wakeup.

Yet in one embodiment of the present invention, the MCB wireless system provides a feature of bi-directional object messaging over a single channel. Both the server and the client can send requests to each other over the same communication channel which was initially established by the client when connecting to the server.

Still in one embodiment of the present invention, the MCB wireless system provides a feature of automatically updating a client screen over a network channel from the server.

These and other features and advantages of the present invention will become apparent to those skilled in the art from the following detailed description, wherein it is shown and described illustrative embodiments of the invention, including best modes contemplated for carrying out the invention. As it will be realized, the invention is capable of modifications in various obvious aspects, all without departing from the spirit and scope of the present invention. Accordingly, the drawings and detailed description are to be regarded as illustrative in nature and not restrictive.

### BRIEF DESCRIPTION OF THE DRAWINGS

FIG. 1 is a schematic view of one embodiment of a wireless network architecture in which a Mobile Classic Blend (MCB) wireless system is provided, in accordance with the principles of the present invention.

FIG. 2 is a schematic view of one embodiment of a Mobile Classic Blend (MCB) wireless system and method showing system and application layers in both a server and a client, in accordance with the principles of the present invention.

FIG. 3 is a process diagram of one embodiment of a user-initiated initial connect in a Mobile Classic Blend (MCB) wireless system, in accordance with the principles of the present invention.

FIG. 4 is a process diagram of one embodiment of a user-initiated event triggering application code at a server in a Mobile Classic Blend (MCB) wireless system, in accordance with the principles of the present invention.

FIG. 5 is a process diagram of one embodiment of a user generating event that triggers widget state caching in a Mobile Classic Blend (MCB) wireless system, in accordance with the principles of the present invention.

FIG. 6 is a process diagram of a prior art wireless system for retrieving a remote widget value.

FIG. 7 is a process diagram of one embodiment of a Mobile Classic Blend (MCB) wireless system for retrieving a remote widget value, in accordance with the principles of the present invention.

FIG. 8 is a process diagram of one embodiment of a server updating a remote widget in a Mobile Classic Blend (MCB) wireless system, in accordance with the principles of the present invention.

FIG. 9 is a process diagram of one embodiment of a server creating a new uncached screen in a Mobile Classic Blend (MCB) wireless system, in accordance with the principles of the present invention.

FIG. 10 is a process diagram of one embodiment of a server creating a new cached screen in a Mobile Classic Blend (MCB) wireless system, in accordance with the principles of the present invention.

FIG. 11 is a process diagram of one embodiment of two-way and one-way messaging in a Mobile Classic Blend (MCB) wireless system, in accordance with the principles of the present invention.

FIG. 12 is a process diagram of one embodiment of two-way message marshalling and unmarshalling in a Mobile Classic Blend (MCB) wireless system, in accordance with the principles of the present invention.

FIG. 13 is a process diagram of one embodiment of one-way message marshalling and unmarshalling in a Mobile Classic Blend (MCB) wireless system, in accordance with the principles of the present invention.

FIG. 14 is a process diagram of one embodiment of minimizing the request handling execution stack for processing incoming messages in a Mobile Classic Blend (MCB) wireless system, in accordance with the principles of the present invention.

FIG. 15 is a process diagram of one embodiment of optimizing memory utilization on client devices with limited processing capability in a Mobile Classic Blend (MCB) wireless system, in accordance with the principles of the present invention.

FIG. 16 is a process diagram of one embodiment of a Short Message Service (SMS) wakeup feature in a Mobile Classic Blend (MCB) wireless system, in accordance with the principles of the present invention.

FIG. 17 is a process diagram of one embodiment of a Short Message Service (SMS) wakeup initial connect feature in a Mobile Classic Blend (MCB) wireless system, in accordance with the principles of the present invention.

### DETAILED DESCRIPTION OF THE PREFERRED EMBODIMENTS

To solve the above and the other problems, the present invention provides a Mobile Classic Blend (“MCB”) wireless system. The MCB wireless system has a server component, client component, and application component for building thin-client wireless applications. The MCB wireless system is optimized for use on medium-latency wireless networks (less than 600 ms round-trip). The MCB wireless system allows two-way dynamic updating capabilities that are currently unable with standard wireless solutions, such as WAP and HTTP. Furthermore, the MCB wireless system allows server-centric programming such that developers do not have to write any client code, yet the developers can create a thin-client wireless application that keeps the look-and-feel of a standalone, native PDA application.

The definitions of terms used in the present invention are as follows:

Application—Code at the server that makes use of the MCB-S framework, and normally provided by a user developer.

Asynchronous Message—A message that does not block the execution of the sending process until a response is received from the message receiver.

Bandwidth—Throughput capacity of a network, and usually quoted in bits/second.

Event binding—An association between client screen widget events and names of application-specific presenter messages. Event bindings are stored in the screen data on the client device.

Latency—Transit time for network data, and usually quoted in round-trip time.

Marshaling—Process of copying data to/from memory into/out of a data stream.

MCB-C—Mobile Classic Blend client component. MCB-C resides at the client device.

MCB-S—Mobile Classic Blend server component. MCB-S resides at the server.

Packet—A set of data that travels through a network to a destination.

PDA—Personal Digital Assistant. A hand-held client device.

Presenter—A type of virtual bean that represents a client screen.

ORB—Object Request Broker that moves objects and messages across a network and performs a variety of additional functions in accordance with the principles of the present invention.

Screen—A form on a window, GUI, or top-level unit of a graphical user interface.

Session—Holds application contextual data on the server.

SMS—Short Message Service, i.e. a carrier-provided service that allows devices to receive messages without regard to device connection state. The device can receive a message as long as the device is “turned on”.

Synchronous Message—A message that blocks the execution of the sending process until a response is received from the message receiver.

Thin-client—A program on the client device which displays a user interface for a server-based application. Thin-clients run minimal or no user application code: most (if not all) of the application code runs on the server. Examples of thin-clients are Web Browsers, Citrix, X-Windows and PCAnywhere.

User—Person who interacts with MCB-C on the device.

Virtual bean—A server-side representation of a client-side widget.

Widget—Screen representation of an I/O component such as a button, list, etc.

Widget state—The set of data that completely defines a widget.

Legends used

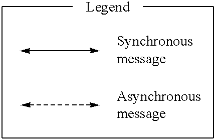

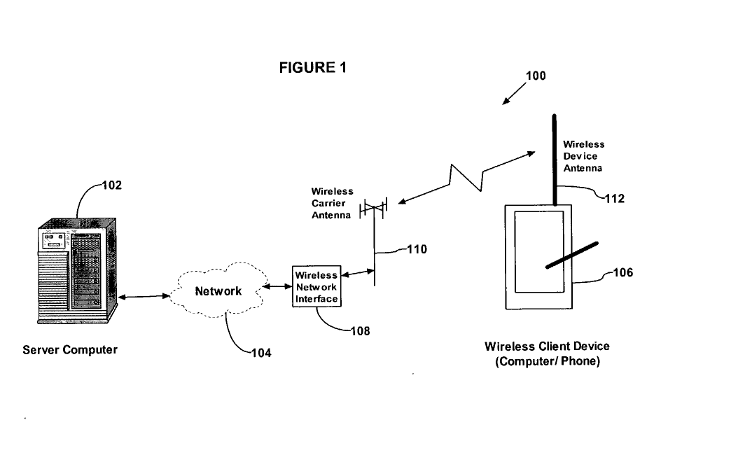

FIG. 1 illustrates one embodiment of a wireless network architecture in which a thin-client, server-centric Mobile Classic Blend (MCB) wireless system 100 is implemented in accordance with the principles of the present invention. The MCB wireless system 100 includes a server computer 102, a network 104, and a wireless data computer/phone device 106. The network 104 can be a public network, such as the Internet, or a private, proprietary network. The network 104 moves data packets between a wireless network interface 108 and the server computer 102. A wireless network interface 108 transfers data packets between the network 104 and the wireless carrier antenna 110. A wireless carrier antenna 110 transfers the data packets to and from a wireless device antenna 112. Signals received at the wireless device antenna 112 are decoded into data packets that are understood by the wireless client device 106, such as a computer, phone, or Personal Data Assistant (PDA).

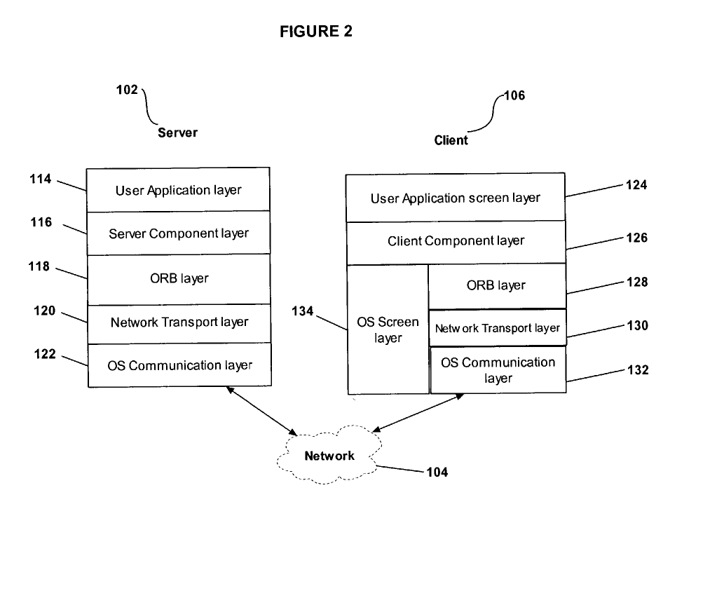

FIG. 2 is a schematic view of one embodiment of a Mobile Classic Blend (MCB) wireless system and method showing system and application layers in both a server and a client, in accordance with the principles of the present invention.

As shown in FIG. 2, the server 102 includes a user application layer 114, a server component layer 116, an ORB (Object Request Broker) layer 118, a network transport layer 120, and an OS (Operating System) layer 122. The user application layer 114 includes user application code, provided by user developers, which use the MCB wireless system 100. The server component layer 116 contains a server-side application and is the interface between the ORB layer 118 and the user application layer 114. The server component layer 116 provides an API (Application Programming Interface) for use by the user application layer 114.

The ORB layer 118 handles messaging and marshalling between remote and local components. The remote component is typically referred to as a client component, and the local component is typically referred to as a server component.

The network transport layer 120 handles packet-based data communication. The OS communication layers 122 and 132 (see below) handle network communications between local and remote network transport layers 120 and 130 (see below). The operating systems are provided externally.

Also shown in FIG. 2, the client (referred to as the wireless client device 106) includes user application screen layer 124, a client component layer 126, an ORB layer 128, a network transport layer 130, an OS communication layer 132, and an OS screen layer 134. The client component layer 126 provides screen analysis and event handling code. The user application screen layer 124 holds screens for the application at the client 106. The screens are provided by a user application developer.

The ORB layer 128 and the network transport layer 130 are analogous to the ORB layer 118 and the network transport layer 120 on the server 102 side. The operating system layers, such as the OS communication layer 132, the OS screen layer 134, and the OS communication layer 122 on the server 102 side are preferably provided externally. It will be appreciated to a person skilled in the art that the operating system layers or some of the operating system layers are provided internally, i.e. provided within the server 102 side and/or the client 106 side.

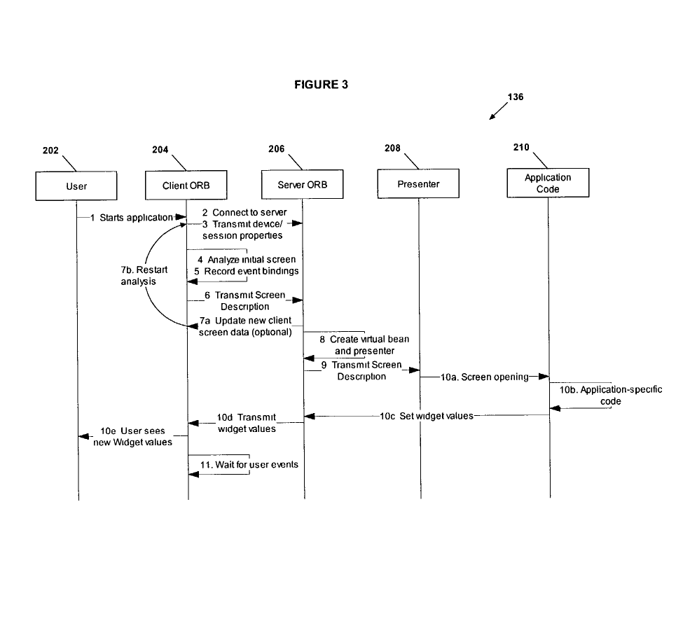

FIG. 3 illustrates an exemplary process 136 of a user-initiated initial connect in the MCB wireless system 100, i.e. a process where a user starts the system 100 from the client device 106, for example, a PDA handheld device. The process 136 includes the following steps:

1. User 202 starts an MCB-C application session on the client device 106, creating a client ORB 204 on the client device 106.

2. The client ORB 204 connects to a server ORB 206 on a server 102.

3. The client ORB 204 transmits device and session properties, including client screen data version, to the server ORB 206.

4. The client ORB 204 analyzes an initial screen.

5. The client ORB 204 records event bindings, i.e. an association between widget events and names of presenter messages.

6. The client ORB 204 transmits a screen description to the server ORB 206.

7. If the server ORB 206 determines that the version of the client screen data is incompatible, (a) the server ORB 206 uploads new client screen data and then aborts. (b) This forces the client ORB 204 to go back to step 3 and try again with the newly uploaded client screen data.

8. If the server ORB 206 determines that the version of the client screen data is compatible, the server ORB 206 receives the screen description and creates virtual beans and presenter 208 (see definitions).

9. The presenter 208 receives the screen description from the server ORB 206.

10. (a) The presenter 208 executes screen opening event. (b) Application-specific code 210 is then executed, (c) provides any initial widget values for the screen. (d) The widget values are then transmitted by the server ORB 206 to the client ORB 204. These initial widget values are then (e) displayed in the widgets on the client device 106 to the user 202.

11. The client ORB 204 waits for user events.

To optimize the use of available bandwidth, the MCB wireless system 100 of the present invention depends on specific screen data, such as screens, widgets and corresponding locations being already available on a client device 106. During routine operations, the only information transmitted is the information which is required for messaging between the client device 106 and the server 102. However, as application code is upgraded on the server 102, this upgraded code may depend on particular screen data being available on the client device 106. To ensure that the client device 106 has compatible screen data, the server ORB 206 checks at initial connect time for screen data version information (see FIG. 3, step 3). Depending on the type of client device, screen data uniqueness may be determined by some of the following attributes: screen data creation date, screen data CRC (Cyclic Redundancy Check), screen data checksum, etc. If the client device 106 does not have a compatible version of the screen data, the server ORB 206 uploads a compatible version of the screen data via the connected device channel (see FIG. 3, step 7(a)). The user 202 does not need to disconnect from the server 102 and may not even be aware that the update process occurred.

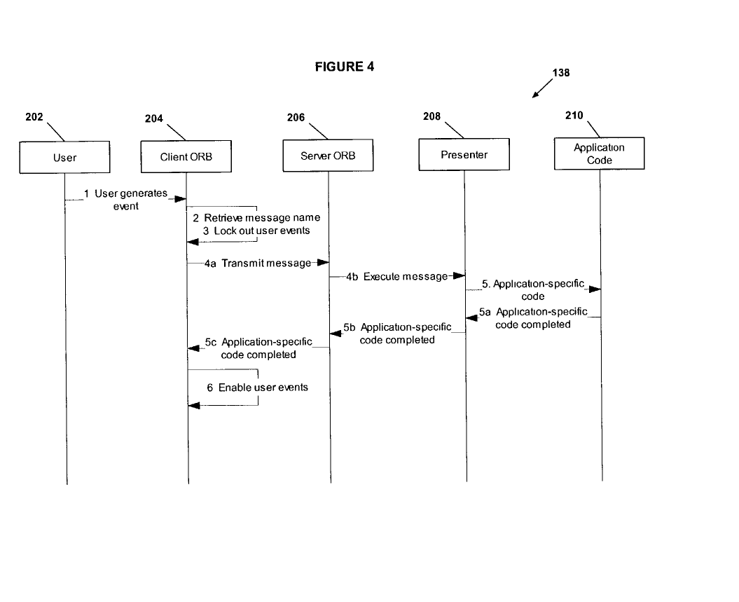

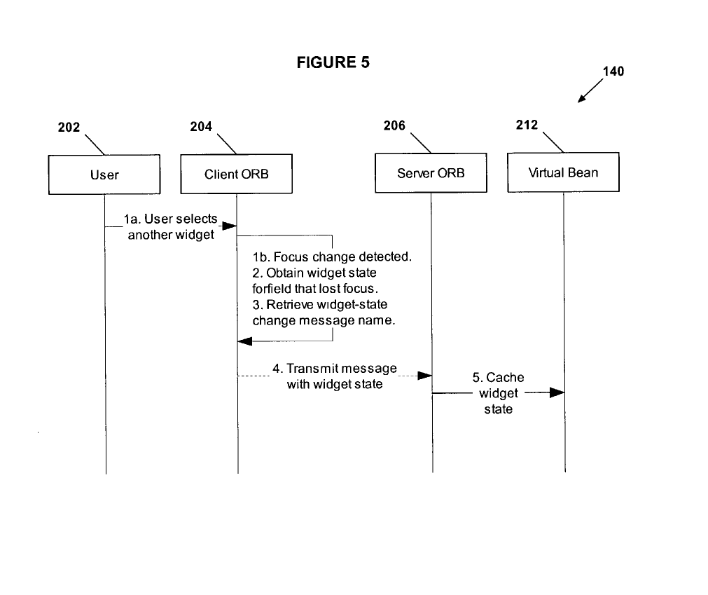

A user interacts with a client device, such as a PDA device, through an input device (e.g. pen or keyboard). These interactions are recognized by the device operating system as user events. Most of these events are handled locally by the operating system or by MCB-C code on the client device 106. However, some events may trigger application code on the server (see FIG. 4) and/or cause caching of widget state (see FIG. 5).

FIG. 4 is an exemplary process 138 of a user-initiated event that triggers application code on the server 102 in the MCB wireless system 100. The process 138 includes the following steps:

1. User 202 manipulates a screen widget to generate a user interface event (e.g. a button press or a list select), which is associated with an event binding (see definition).

2. A client ORB 204 retrieves a message name from the event binding for the user event.

3. The client ORB 204 locks input to the screen to prevent further user interaction.

4. (a) The client ORB 204 transmits the message name to the server ORB 206, which (b) invokes the message by name on the presenter 208 associated with the screen.

5. The presenter 208 executes the application-specific code, (a) returns a value back to the presenter 208, which (b) returns the value back to the server ORB 206, which (c) returns the value back to the client ORB 204.

6. After the processing of the application functionality is complete, the client ORB 204 unlocks input to the screen.

To speed up server access to client widget contents, the MCB wireless system 100 has implemented a widget state caching technique on the server ORB 206. The server ORB 206 has a virtual bean 212, for each widget, which contains a representation of the client-side widget's state. The server ORB 206 ensures that this virtual bean's 212 state is updated to the current value before any server-side user application code is executed.

FIG. 5 illustrates an exemplary process 140 of an event which triggers widget state caching in the MCB wireless system 100. In this case, a user changes input focus from one widget to another thereby causing the client ORB 204 to send a state caching message to server ORB 206. The widget caching event process 140 includes the following steps:

1. (a) User 202 manipulates a screen widget that generates an event that (b) causes the client ORB 204 to send the widget's state to the server ORB 206 for caching.

2. The client ORB 204 retrieves the widget state from the widget.

3. The client ORB 204 retrieves the message name associated with the type of widget state change.

4. The client ORB 204 transmits the message and the new state to the widget's associated virtual bean 212 on server ORB 206. This is performed as a one-way message (see definition).

5. At the server ORB 206, the virtual bean 212 caches the new state for later retrieval by application code.

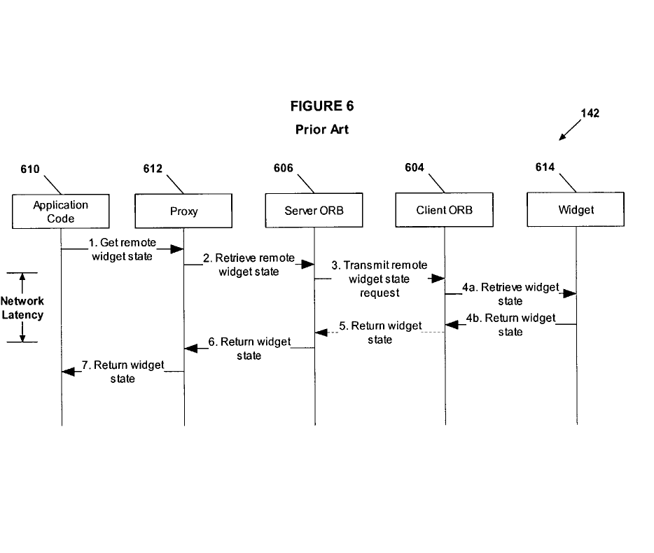

FIG. 6 shows a typical prior art process 142 of remote widget data access. The remote widget data access process includes the following steps:

1. Some server-based application code 610 requests a widget's 614 state through a proxy 612 for the widget.

2. The proxy 612 forwards the request to the server ORB 606.

3. Server ORB 606 forwards the request through the network to the client ORB 604.

4. (a) Client ORB 604 retrieves the widget state from widget 614. (b) Widget 614 returns the widget state to the client ORB 604.

5. The client ORB 604 transmits the widget state over the network back to the server ORB 606.

6. The server ORB 606 returns the widget state back to the proxy 612.

7. Proxy 612 returns widget state back to the application code 610.

FIG. 6 shows how the network latency dimension affects the retrieval time for the remote widget value.

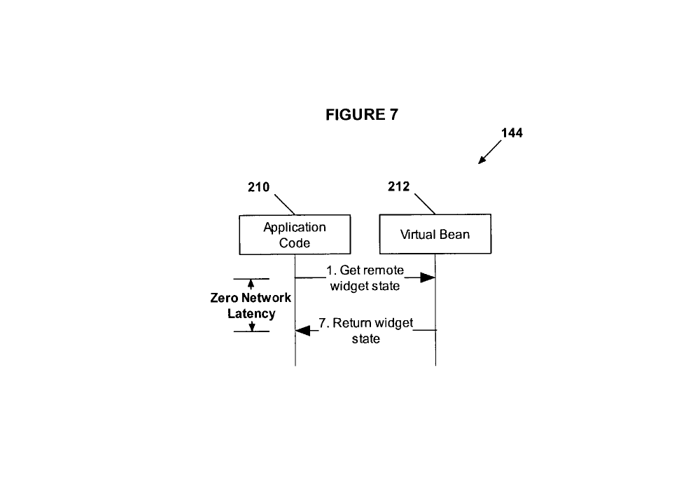

FIG. 7 shows a process 144, in accordance with the principles of the present invention, for a remote widget value request similar to that shown in FIG. 6. The benefit resulting from the implementation in FIG. 7 is that the process 144 generates no network traffic, thus no network latency is experienced in the remote widget value request. This, in turn, substantially increases performance for application code. Process 144 includes the following steps:

1. Application code 210 requests remote widget state from virtual bean 212.

2. Virtual bean 212 returns cached widget state back to application code 210.

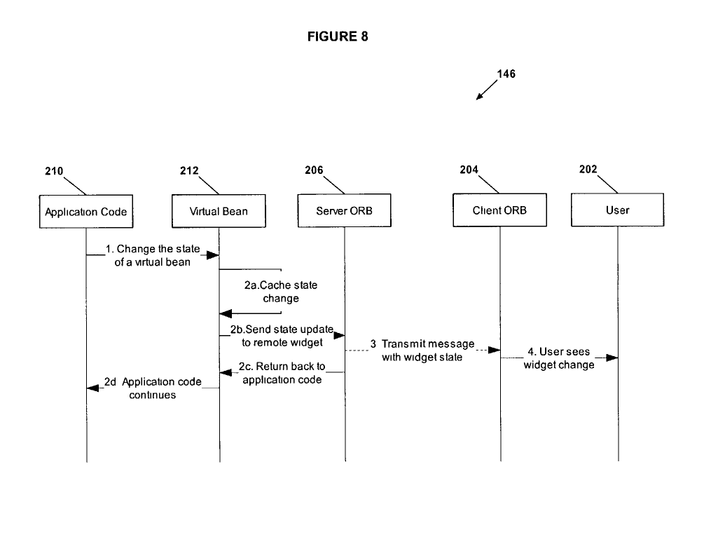

FIG. 8 illustrates a process 146, in accordance with the principles of the present invention, for a server updating a remote widget. Process 146 demonstrates how the server-initiated virtual bean state changes are cached and propagated to the client without requiring application-specific code. Process 146 includes the following steps: 1.

Server application code 210 sends a state-change request to a virtual bean 212.

2. (a) The virtual bean 212 caches the new internal state. (b) The virtual bean 212 forwards the state-change message to the server ORB 206 for asynchronous updating of the remote widget. (c) The server ORB 206 returns control to the virtual bean 212. (d) The virtual bean 212 returns control to the application code 210.

3. The server ORB 206 sends an asynchronous message (see definition) to the client ORB 204 containing the new widget state.

4. The client ORB 204 receives the message and updates the widget's state. The screen reflects the widget state change, which is seen by user 202.

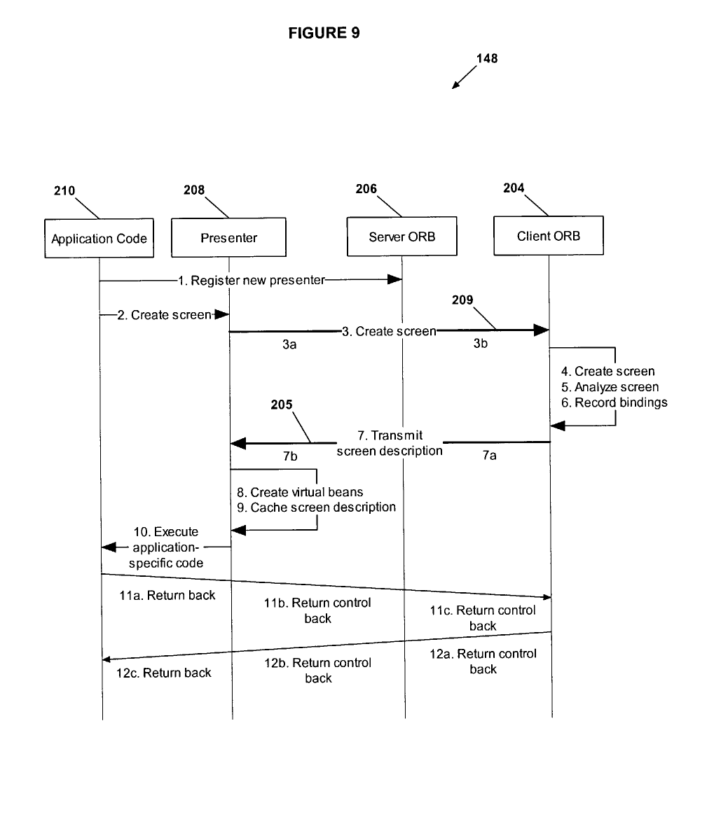

FIG. 9 illustrates a process 148, in accordance with the principles of the present invention, of server creating a new uncached screen. The MCB wireless system 100 will create a new uncached screen the first time it opens a screen for a user. The process 148 includes the following steps: 1. The server application code 210 registers a new presenter 208 with a server ORB 206 2. The application code 210 sends a “create screen” message along with a screen identifier to the new presenter 208. 3. (a) The presenter 208 transmits a “create screen” message along with the screen identifier to the server ORB 206. (b) The server ORB 206 transmits a synchronous message 209 to the client ORB 204. 4. The client ORB 204 creates a screen corresponding to the screen identifier. 5. The client ORB 204 analyzes the screen. 6. The client ORB 204 records event bindings. 7. (a) The client ORB 204 synchronously transmits a message 205 containing the screen description to the server ORB 206. (b) The server ORB 206 forwards the screen description to the presenter 208.

8. The presenter 208 receives the screen description and creates virtual beans. 9. The presenter 208 caches the screen description. 10. The application-specific code 210 is executed. At this point, the presenter 208 may provide any initial widget values for the screen. 11. Returning from message 205, (a) Application code 210 returns control back to the presenter 208. (b) presenter 208 returns control back to server ORB 206. (c) Server ORB 206 returns control back to client ORB 204. 12. Returning from message 209, (a) client ORB 204 returns control back to the server ORB 206. (b) Server ORB 206 returns control back to presenter 208. (c) presenter 208 returns back control to Application Code 210.

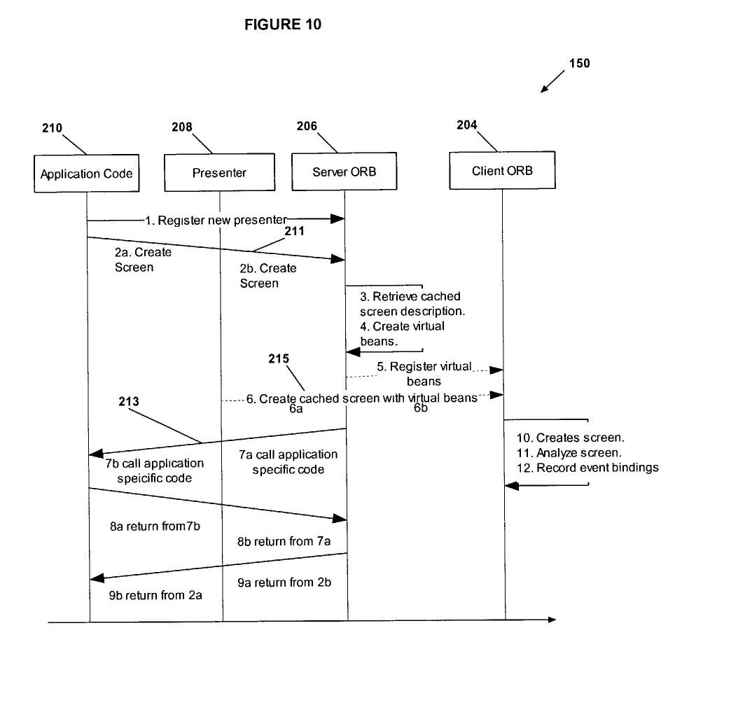

FIG. 10 illustrates an exemplary process 150 of a server ORB 206 creating a new cached screen which uses a server-side screen description cache to improve responsiveness when creating new screens by eliminating the need for synchronous messaging required in Process 148. The process 150 includes the following steps:

1. The server application code 210 registers a new presenter 208 with the server ORB 206.

2. (a) The application code 210 sends a “create screen” message 211 along with a screen identifier to the new presenter 208. (b) The presenter 208 forwards a message 211 along with the screen identifier to the server ORB 206.

3. The server ORB 206 retrieves the cached screen description for the given screen identifier.

4. The server ORB 206 creates virtual beans for the cached screen description.

5. The server ORB 206 transmits an asynchronous message to the client ORB 204 to register the new virtual beans.

6. (a) The presenter 208 sends a “create cached screen” message 215 along with the screen identifier and virtual beans to the server ORB 206. (b) The server ORB 206 asynchronously forwards the message to the client ORB 204.

7. Server ORB 206 now send a message 213 to presenter 208 to execute application-specific code. (b) Presenter 208 forwards message 213 to application-specific code 210. Application-specific code 210 may provide initial widget values for the screen.

8. (a) Application-specific code 210 returns control for message 213 back to presenter 208. (b) Presenter 208 returns control for message 213 back to server ORB 206.

9. (a) Server ORB 206 returns control back to presenter 208 for message 211. (b) Presenter 208 returns control back to application-specific code 210 for message 211. Application-specific code 210 continues processing.

10. After receiving the asynchronous message 215, the client ORB 204 creates a screen corresponding to the screen identifier.

11. The client ORB 204 analyzes the screen.

12. The client ORB 204 records event bindings.

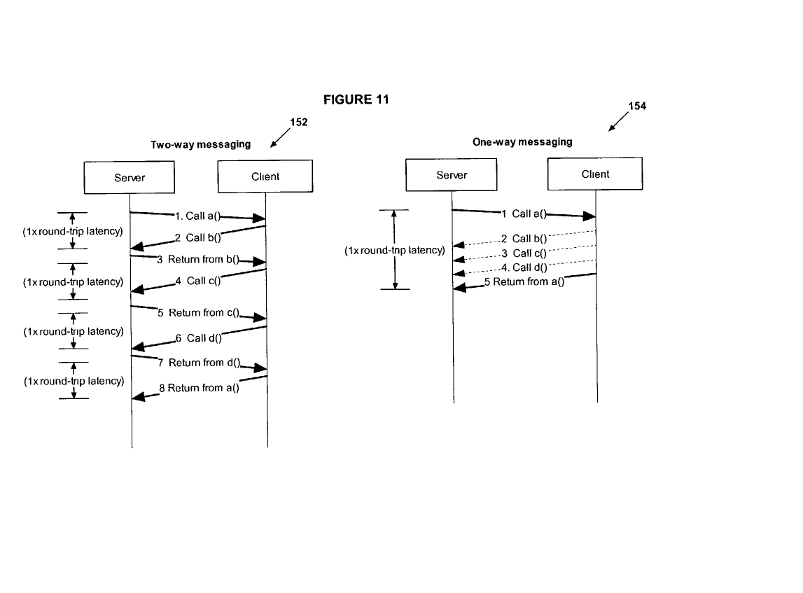

FIG. 11 illustrates a two-way messaging process 152 in comparison to a one-way messaging process 154, which highlights message sending between a server and a client. Two-way messages are synchronous calls over the network while one-way messages are asynchronous over the network. The two-way process 152 shows a two-way call which triggers (3) three successive two-way calls and the one-way process 154 shows a two-way call which triggers three successive one-way calls. The two-way process 152 requires 4 times the network latency to complete while the one-way process 154 requires one time the network latency. As shown in FIG. 11, one-way messages have a substantial advantage over two-way messages due to their lack of network latency. Wherever possible, the MCB wireless system 100 uses one-way messaging. The system's transport layer also provides streaming behavior that guarantees delivery and preserves the transmission order of both one-way and two-way messages.

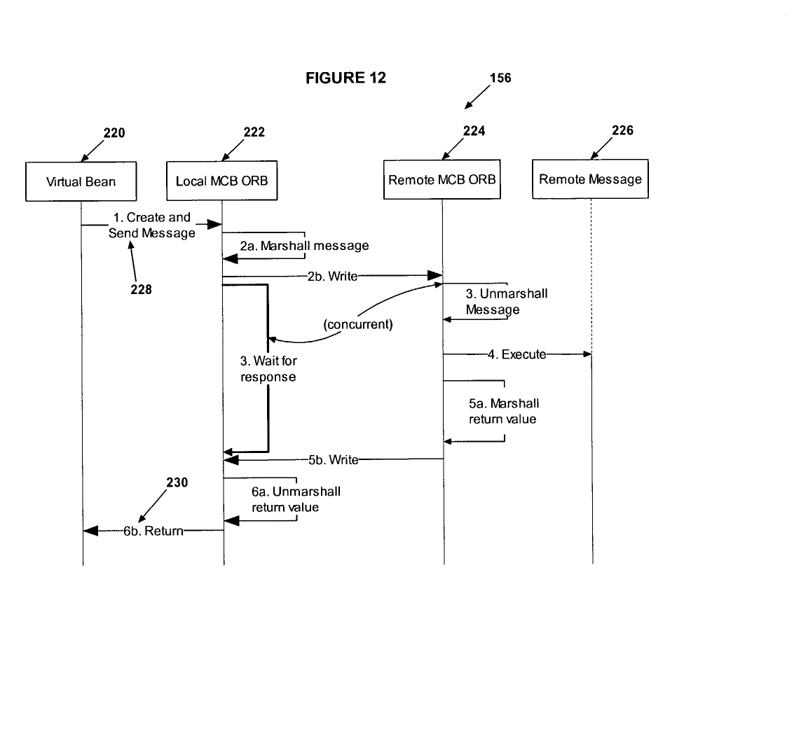

FIG. 12 illustrates a process 156 for two-way message marshalling and unmarshalling. It is noted that the invoking message send 228 has to wait until the return value is returned by the remote ORB 224 before it can return a value (230). The process 156 includes the following steps:

1. A local ORB (e.g. client or server) 222 creates a message object using a message name, arguments, registered receiver and return id.

2. The local ORB 222 marshals the packet and immediately writes it to a remote ORB 224.

3. The local ORB 222 waits for a return value using the return id.

4. The remote ORB 224 narwhals and executes the message.

5. The remote ORB 224 marshals and writes the return value.

6. Local ORB 222 narwhals the return value and returns it to the caller.

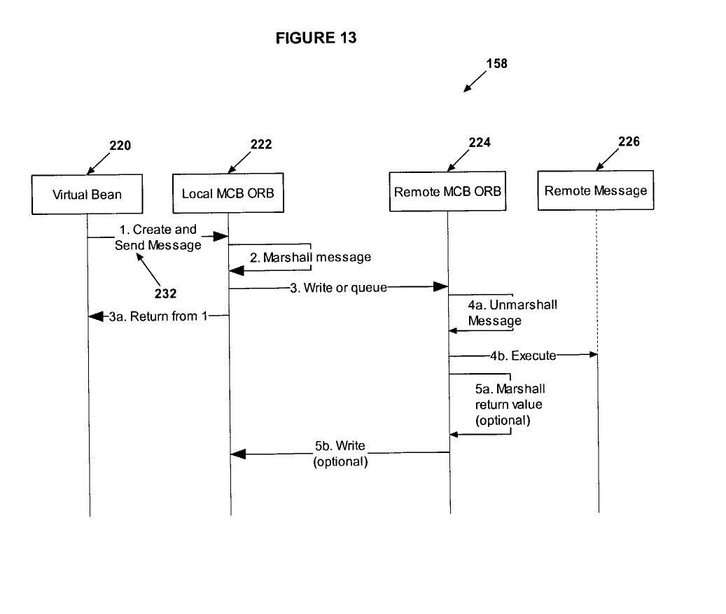

FIG. 13 illustrates a process 158 of one-way message and return value marshalling. It is noted that a caller (Virtual Bean—1. Create and Send Message) does not wait until the return value is returned by the remote ORB. The process 158 includes the following steps:

1. A local MCB (client or server) creates a message object using the message name, arguments, registered receiver, return id (if present) and delivery mode (imminent, or otherwise).

2. A local MCB marshals the packet.

3. Imminent messages are immediately written to a remote ORB. Messages with other message modes (a) are queued for later writing.

4. A remote MCB (a) narwhals and (b) executes the message.

5. A remote MCB (a) marshals and (b) writes the return value (if necessary).

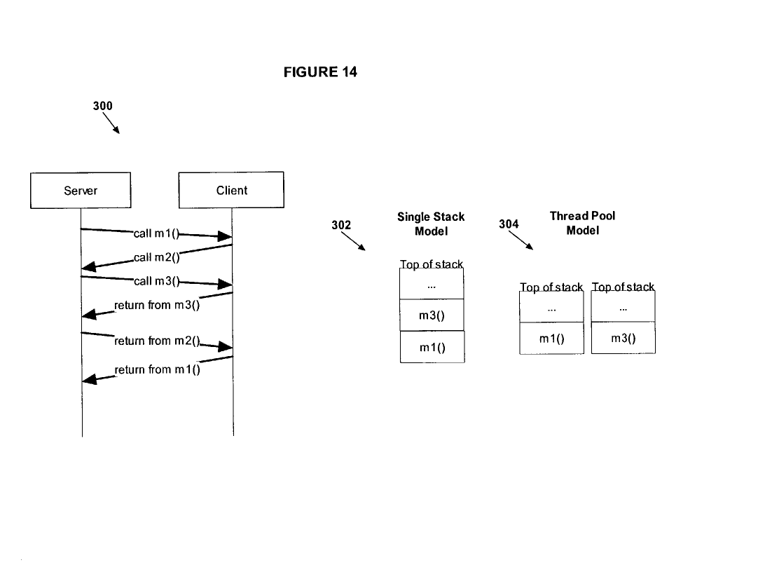

FIG. 14 shows a process 300 of a series of nested message sends between a client and a server and two models for executing that process, a single-stack model 302 and a thread-pool model 304. Both models as shown in FIG. 14 are known in the computer art. The thread-pool models 304 are normally used in large, scalable architectures. The system 100 preferably uses the thread-pool model. This optimization allows the system 100 to execute in resource-limited devices.

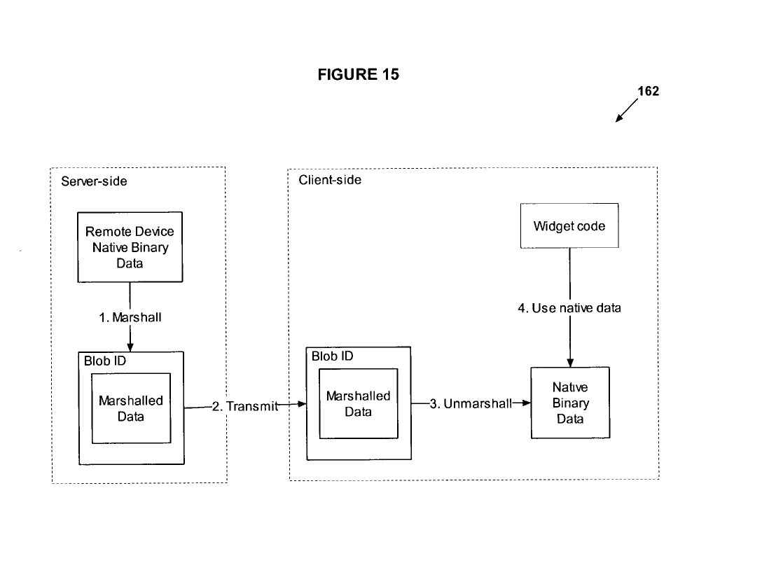

FIG. 15 shows a process 162 of how the MCB wireless system 100 optimizes the limited processing capabilities of the device by transmitting data in as close to the remote device's native binary data format as possible. The process 162 includes the following steps:

1. The remote device native binary data is marshaled and wrapped within a BLOB (Binary Large Object) which is referenced by a BLOB ID.

2. The BLOB is transmitted over the network to a client-side.

3. At the client, the data is unmarshalled, and the native binary data is recreated.

4. The widget code can then access the binary data as needed.

This process reduces the amount of conversion required by the device and substantially speeds up the updating and rendering of a widget state.

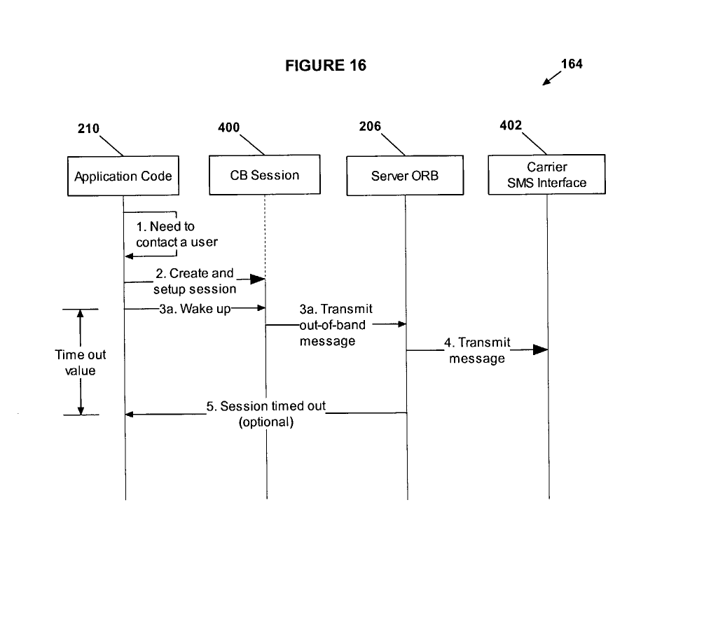

FIG. 16 shows a process 164 by which user-provided application code 210 contacts a non-connected user. The process 164 includes the following steps:

1. User-provided application code 210 determines that an SMS wakeup is necessary.

2. The application code 210 creates a Classic Blend session (or CB session) 400 with the necessary application context data for use by a future SMS wakeup connection.

3. The application code 210 forwards the new CB session 400 to the server ORB 206 for SMS transmission.

4. The server ORB 400 transmits encoded SMS message via carrier-provided SMS interface 402.

5. If a client ORB 204 does not connect to the server ORB 206 within an allotted time, the pending CB session 400 is removed and the application code 210 is notified of expiration.

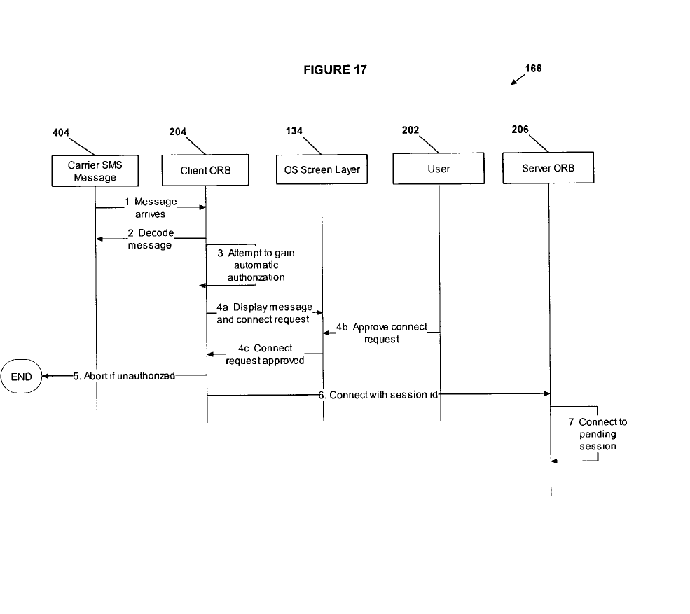

FIG. 17 shows a process 166 of how a disconnected client ORB 204 is messaged and instructed to contact a server ORB 206. A session ID is encoded within an SMS message. The session ID allows the server to find the pending CB session 400 that was created by the user application code 210 (see in FIG. 16). The process 166 includes the following steps:

1. A carrier SMS message 404 arrives at a client device with an encoded MCB message.

2. The client ORB 204 decodes the message and determines what application the originating server ORB 206 (see in FIG. 16) requests to start.

3. If preferences allow automatic authorization, the client ORB 204 gains authorization.

4. If directed by preferences, the client ORB 204 will attempt to obtain authorization by presenting the encoded user message and requesting the user 202 to grant authorization. If the user 202 authorizes the connect request, the client ORB 204 gains authorization.

5. If the client ORB 204 does not gain authorization, the process 166 is aborted.

6. Client ORB 204 connects to the server ORB 206. On connection, the pending session 400 provides a context for the application.

7. The user-initiated initial connect process 136 as shown in FIG. 3 is performed.

From the above description and drawings, it will be understood by those of ordinary skill in the art that the particular embodiments shown and described are for purposes of illustration only and are not intended to limit the scope of the present invention. Those of ordinary skill in the art will recognize that the present invention may be embodied in other specific forms without departing from its spirit or essential characteristics. References to details of particular embodiments are not intended to limit the scope of the invention.

What is claimed is:

1. A wireless network system capable of implementing a wireless thin-client, server-centric framework.

2. The wireless network system of claim 1, wherein the wireless thin-client, server-centric framework is adapted for use on medium-latency wireless network with less than 600 ms round-trip.

3. A wireless network method capable of implementing a wireless thin-client, server-centric framework.

4. The wireless network method of claim 3, wherein the wireless thin-client, server-centric framework is adapted for use on medium-latency wireless network with less than 600 ms round-trip.
